(19) United States
(12) Patent Application Publication
(10) Pub. No.: US 2026/0261100 A1
(43) Pub. Date: Sep. 3, 2026

(54) SPARK PLUG WITH TAPERED BREATHING SPACE

(71) Applicant: Robert Bosch GmbH, Stuttgart (DE)

(72) Inventors: Alexander Schramm, Knetzgau (DE); Andreas Benz, Bamberg (DE)

(21) Appl. No.: 18/718,299

(22) PCT Filed: Nov. 24, 2022
(86) PCT No.: PCT/EP2022/083106

§ 371 Date: Jun. 10, 2024

(30) Foreign Application Priority Data
Dec. 22, 2021 (DE) 10 2021 214 896.4

(51) Int. Cl. H01T 13/54; H01T 13/34

(52) U.S. Cl. CPC H01T 13/54; H01T 13/34

(57) ABSTRACT

A spark plug with a longitudinal axis. The spark plug including a housing with a longitudinal bore, as a result of which the housing has a housing wall with an inner face; an insulator arranged within the housing and having a combustion chamber-side insulator tip which is flush with a plane extending perpendicularly to the longitudinal axis; a center electrode arranged at least partially within the insulator; and a ground electrode arranged within the housing, wherein the ground and center electrodes are arranged such that they form a spark gap which is within the housing. The housing has, at its combustion chamber-side end, a first inside diameter and, within the housing in the plane, a second inside diameter. The first diameter is greater than the second diameter. A breathing space formed within the housing tapers from its combustion chamber-side end to its combustion chamber-remote end.

### FIELD

The present invention relates to a spark plug.

### BACKGROUND INFORMATION

In many of the spark plugs used today, the ground electrode is arranged on the combustion chamber-side end face of the housing and the spark gap is formed outside the housing. The center electrode also often projects out of the housing and into the combustion chamber. As a result, the electrodes and the insulator can absorb a lot of heat from the combustion chamber. Furthermore, the breathing space, which extends between the housing and the insulator with the center electrode, is usually designed to be cylindrical in shape and plays a subordinate role in spark plugs whose spark gap is formed outside the housing.

These spark plugs are optimized for use in gasoline-powered internal combustion engines.

There are increasing plans to use hydrogen as a fuel in internal combustion engines, which poses new challenges for the construction and design of spark plugs. Hydrogen burns very quickly, so that ignition takes place at a later point in time and at a higher combustion chamber pressure than with other fuels. This creates high temperatures in the combustion chamber. In addition, hydrogen tends to self-ignite even at relatively low temperatures. To prevent this self-ignition, all spark plug components must be as cold as possible.

### SUMMARY

An object of the present invention is to provide a spark plug that has a low component temperature.

This object may be achieved with the spark plug according to the present invention. According to an example embodiment of the present invention, the housing has a first inside diameter D1 at its combustion chamber-side end and, within the housing in the plane E1, a second inside diameter D2, wherein the first inside diameter D1 is greater than the second inside diameter D2, so that a breathing space formed within the housing tapers from its combustion chamber-side end to its combustion chamber-remote end.

The spark plug according to an example embodiment of the present invention with a longitudinal axis has a housing with a longitudinal bore, as a result of which the housing has a housing wall with an inner face, an insulator which is arranged within the housing and has a combustion chamber-side insulator tip which is flush with a plane E1 extending perpendicularly to the longitudinal axis, a center electrode which is arranged at least partially within the insulator, and a ground electrode which is arranged within the housing, wherein the ground electrode and the center electrode are arranged such that they form a spark gap and the spark gap is formed within the housing.

According to an example embodiment of the present invention, it is provided that the housing has, at its combustion chamber-side end, a first inside diameter D1 and, within the housing in the plane E1, a second inside diameter D2, wherein the first inside diameter D1 is greater than the second inside diameter D2, so that a breathing space formed within the housing tapers from its combustion chamber-side end to its combustion chamber-remote end. The breathing space is the space within the spark plug housing and is delimited by the housing wall and the insulator. The region of the breathing space from its combustion chamber-remote end to the spark gap is referred to as the dead space, since the fuel-air mixture has difficulty flowing in and out of this area. By tapering the breathing space, the dead space is reduced and there is less of the fuel-air mixture in the region of the insulator and the electrodes, which means that less heat energy is transferred to the electrodes, the insulator and the housing by convection and radiation after ignition. The housing volume is also increased, leading to a further reduction in temperature in the breathing space and in the components. The resulting lower temperature load reduces wear on the electrodes and the risk of pre-ignition or auto-ignition. Furthermore, it is possible to design the shape of the breathing space such that the flow of the fuel-air mixture in the breathing space is directed accordingly.

The arrangement of the electrodes within the housing has the further advantage that the insulator, the ground electrode and the center electrode can be designed shorter. As a result, they project less into the combustion chamber. On the one hand, the components absorb less heat from the combustion chamber and, on the other hand, the heat dissipation from the components via the housing into a cylinder head, in which the spark plug according to the present invention is mounted, is more effective. Within the framework of this application, the term “combustion chamber” refers to the combustion chamber of an internal combustion engine cylinder, in the cylinder head of which the spark plug according to the present invention can be mounted. The breathing space of the spark plug does not count as the “combustion chamber” for the purposes of this application.

Further advantageous embodiments of the present invention are disclosed herein.

According to an example embodiment of the present invention, it is advantageously provided that the second inside diameter D2 corresponds to 35% to 80% of the first inside diameter D1. The second inside diameter D2 also determines the space available for the insulator, in particular for the insulator tip in the housing. The insulator tip has a diameter D3 that is smaller than the second inside diameter D2. Due to the tapered shape of the breathing space, the insulator tip has a smaller surface area that can absorb heat from the breathing space. Furthermore, the smaller insulator surface area projecting into the breathing space means that the insulator and the center electrode are less stressed by the pulsating pressures that arise during combustion. This reduces the load on the mechanical fixing of the insulator in the spark plug housing and makes the spark plug more robust.

In a further development of the present invention, it is provided that the insulator tip delimits the breathing space at least partially at its combustion chamber-remote end. The breathing space is delimited by the housing and the insulator. The housing and the breathing space are open in the direction of the combustion chamber. For example, the insulator tip is flush with a surface of the housing that delimits the breathing space at its combustion chamber-remote end. For example, it is also possible for only the insulator tip to delimit the breathing space at the combustion chamber-remote end, and the inner face of the housing wall delimits the breathing space in the radial direction. As a result, it is ensured that the breathing space has little or no dead space. Furthermore, the heat-absorbing insulator surface which is in contact with the breathing space is reduced to a minimum. The insulator tip also does not project into the breathing space, so that the flow of the fuel-air mixture in the breathing space is not disrupted by any edges of the insulator tip.

In a further development of the present invention, it is provided that the housing wall of the housing laterally delimits the breathing space, resulting in the tapered shape of the breathing space.

In one example embodiment of the further development of the present invention, it is provided that the shape of the breathing space results from straight surfaces of the housing, in particular wherein a first transition from the inner face of the housing wall to a combustion chamber-side end face of the housing, and/or a second transition from the inner face of the housing wall to a surface of the housing that delimits the breathing space at its combustion chamber-remote end, are rounded. This results in the advantage whereby the surfaces delimiting the breathing space do not have any edges that could irritate the fuel-air mixture flow.

In an alternative embodiment of the further development of the present invention, it is provided that the shape of the breathing space is composed of a plurality of partial surfaces that are lined up in parallel with the longitudinal axis, wherein a single partial surface can be straight or curved and different partial surfaces can have different radii of curvature, so that overall a contour with a curved shape arises. This results in the advantages described above.

In a further alternative embodiment of the further development of the present invention, it is provided that the shape of the breathing space is composed of a conical section and a cylindrical section with a constant diameter. In particular, the conical section is arranged closer to the combustion chamber than the cylindrical section. This results, for example, in the breathing space having the shape of the divergent part of a de Laval nozzle. This has the advantage that a larger part of the outflowing burnt fuel-air mixture is guided in parallel with the longitudinal axis of the spark plug, thus increasing the penetration depth into the combustion chamber of a cylinder.

In one embodiment of the spark plug according to the present invention, it is provided that the contour is rotationally symmetrical and/or mirror-symmetrical, wherein the longitudinal axis of the spark plug is the axis of symmetry. This results in a simple production of the spark plug housing.

In another embodiment of the spark plug according to the present invention, it is provided that the contour is rotationally symmetrical and/or mirror-symmetrical, wherein the axis of symmetry is at a distance from the longitudinal axis of the spark plug. By spacing the axis of symmetry of the breathing space apart from the longitudinal axis of the spark plug, the flow of the fuel-air mixture can be directed in a targeted manner.

In another embodiment of the spark plug according to the present invention, it is provided that the contour is asymmetrical. As a result, the flow of the fuel-air mixture can also be directed in a targeted manner.

In an advantageous further development of the embodiments of the spark plug according to the present invention, the spark gap has a distance T, where T=0.1 mm or greater and/or T=15 mm or less, from a combustion chamber-side end face of the housing. The distance T extends from the combustion chamber-side end face of the housing to the combustion chamber-side end of the spark gap. This results in the spark gap being arranged within the housing. This negative spark position makes it possible to design the center electrode and the insulator to be shorter than usual, so that on the one hand the center electrode and the insulator do not protrude as far into the combustion chamber, and the path for heat dissipation is shorter and thus the heat dissipation is more effective.

According to an example embodiment of the present invention, advantageously, for example, the width of the spark gap is not greater than 0.5 mm, in particular not greater than 0.2 mm. The smaller the spark gap, the lower the voltage required to generate an ignition spark.

According to an example embodiment of the present invention, it is also advantageous that the width of the spark gap is at least 0.05 mm, in particular not less than 0.1 mm. This means that the spark gap is not too small. A very small spark gap poses particular challenges on accuracy during spark plug production. A deviation from the most parallel possible alignment of the electrode ignition surfaces has a greater effect with a small spark gap, such as uneven wear of the ignition surface, than with a larger spark gap. Thus, the lower limit for the width of the spark gap is a good compromise for a small spark gap to reduce the ignition voltage requirement and wear on the one hand and, on the other hand, is a justifiable effort for a consistently good quality of the alignment of the ignition surfaces with respect to one another during spark plug production.

The spark plug according to the present invention and the further development thereof is a hydrogen spark plug which is designed to be used in a hydrogen-powered engine and to ignite the ignitable hydrogen-containing fuel-air mixture. The fuel can contain up to 100% hydrogen, i.e. the fuel can be hydrogen or a hydrogen-gas mixture.

However, the spark plug according to the present invention is not limited to operation with hydrogen. The spark plug according to the present invention can also be used for natural gas or gasoline internal combustion engines. However, the spark plug according to the present invention is optimized for operation with hydrogen.

For example, the spark plug can have a cap that is arranged at the combustion chamber-side end of the housing, so that the spark plug is a pre-chamber spark plug.

### BRIEF DESCRIPTION OF THE DRAWINGS

FIG. 1 shows a first example of a tapered breathing space of the spark plug according to the present invention.

FIG. 2 shows a second example of a tapered breathing space of the spark plug according to the present invention.

FIG. 3 shows a third example of a tapered breathing space of the spark plug according to the present invention.

### DETAILED DESCRIPTION OF EXAMPLE EMBODIMENTS

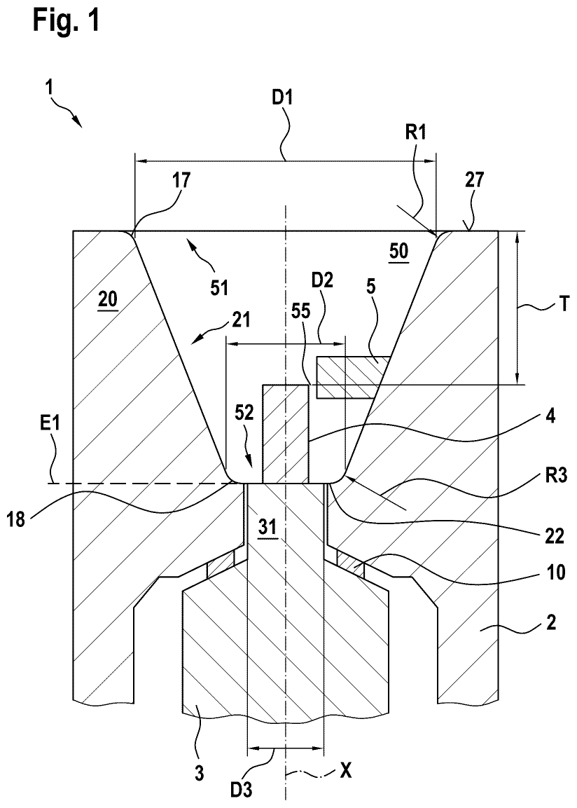

FIGS. 1 to 3 each schematically show the combustion chamber-side half of a spark plug 1 according to the present invention. The spark plug 1 has a housing 2 that has a longitudinal bore, so that the housing 2 has a housing wall 20 with an inner face 21. The spark plug 1 also has an insulator 3 arranged within the housing 2 with a combustion chamber-side insulator tip 31. The insulator tip 31 is flush with a plane El extending perpendicularly to the longitudinal axis X of the spark plug 1. The insulator tip 31 has a diameter D3.

A center electrode 4 is arranged within the insulator 3 and a ground electrode 5 is arranged within the housing 2. The ground electrode 5 is designed here as a side electrode. The ground electrode 5 can also be designed as a front electrode. The ground electrode 5 can, for example, be arranged in a recess in the inner face 21 of the housing wall 20 or inserted in a bore through the housing wall 20 or arranged on a projection on the inner face 21 of the housing wall 20. This local recess or protrusion on the inner face 21 of the housing wall 20 can be ignored when considering the shape of the breathing space 50. The center electrodes 4 and the ground electrode 5 together form a radial spark gap 55, for example. The spark gap 55 has a distance T from the combustion chamber-side end face 27 of the housing 2 and is formed within the housing 2.

The breathing space 50 is the space at the combustion chamber-side end of the spark plug 1 which is delimited by the housing 2 in the radial direction and by the insulator 3 and, if applicable, a housing section 22 in the axial direction in relation to the spark plug longitudinal axis X. The housing 2 has an opening at its combustion chamber-side end due to the longitudinal bore. Accordingly, the breathing space 50 is also open at its combustion chamber-side end 51. The plane of the combustion chamber-side end face 27 of the housing delimits the breathing space 50 at its combustion chamber-side end 51. The housing 2 has a first inside diameter D1 at its combustion chamber-side end and, within the housing 2 in the plane E1, a second inside diameter D2. The first inside diameter D1 is greater than the second inside diameter D2, so that the breathing space 50 formed within the housing 2 tapers from its combustion chamber-side end 51 to its combustion chamber-remote end 52. The second inside diameter D2 of the housing 50 is greater than the diameter D3 of the insulator tip 31. The breathing space 50 is radially delimited by the housing wall 20. The housing wall 20 has an increasing wall thickness corresponding to the tapering of the breathing space 50.

A sealing element 10 is arranged between the insulator 3 and the housing 2, and seals the space between the housing 2 and the insulator 3. Thus, no gases can flow from the breathing space 50 along the longitudinal bore of the housing 2 to the combustion chamber-remote end of the housing 2 and the spark plug 1.

In the exemplary embodiment shown in FIG. 1, the breathing space is delimited at its combustion chamber-remote end 52 by a surface 22 of housing 2 and by the insulator tip 31 of the insulator 3. The insulator tip 31 is flush with the housing surface 22, so that only the center electrode 4 projects into the breathing space 50 at the combustion chamber-remote end 52 of the breathing space 50.

The shape of the breathing space 50 results from straight surfaces of the inner face 21 of the housing wall 20. A first transition 17 from the inner face 21 of the housing wall 20 to a combustion chamber-side end face 27 of the housing 2 can be rounded. The rounding radius of the first transition 17 is R1. Additionally or alternatively, a second transition 18 from the inner face 21 of the housing wall 20 to a surface 22 of the housing 2 that delimits the breathing space 50 at its combustion chamber-remote end 52 can be rounded. The rounding radius of the second transition 18 is R2. The rounding radii R1 and R2 can be the same or different.

The other figures show further exemplary embodiments of the spark plug 1 according to the present invention. Identical components are labeled with the same reference signs. In the following, the differences between the exemplary embodiments will be discussed.

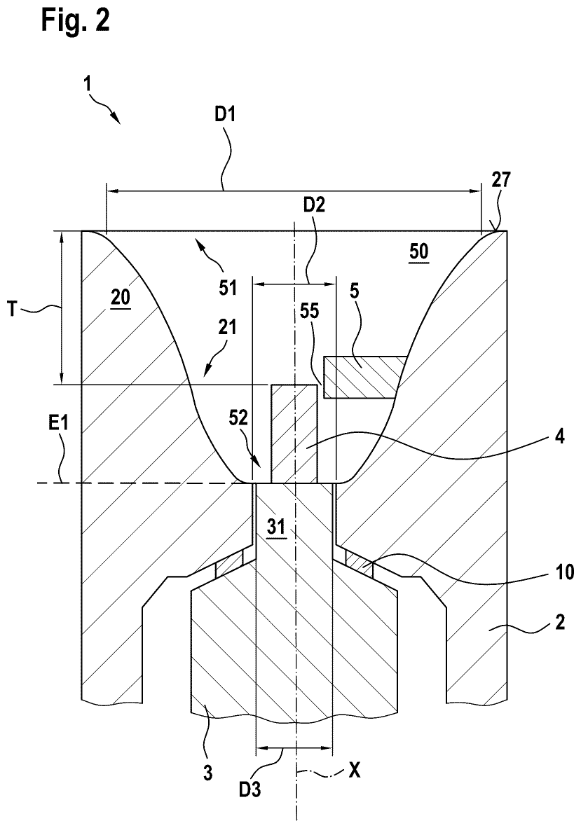

FIG. 2 shows a second example of a tapered breathing space of the spark plug 1 according to the present invention. In contrast with the first example shown in FIG. 1, only the insulator tip 31 delimits the breathing space at its combustion chamber-remote end. The inner face of the housing wall delimits the breathing space in the radial direction to the longitudinal axis of the spark plug. The inner face of the housing wall is made up of a plurality of sections that are lined up in parallel with the longitudinal axis. The sections can have a straight surface or a curved surface with different radii of curvature, resulting in a corrugated shape of the housing wall inner face.

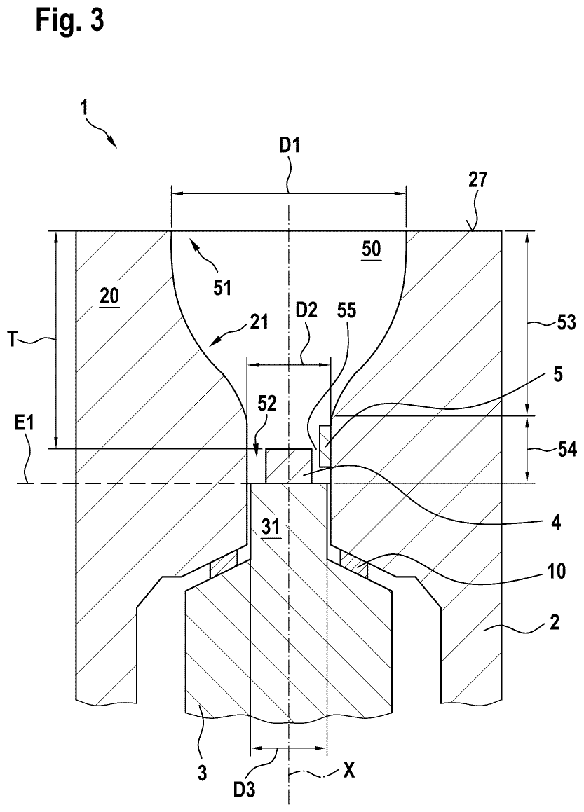

FIG. 3 shows a third example of a tapered breathing space of the spark plug 1 according to the present invention. In contrast with the first example shown in FIG. 1, only the insulator tip 31 delimits the breathing space at its combustion chamber-remote end. The inner face of the housing wall delimits the breathing space in the radial direction to the longitudinal axis of the spark plug. The shape of the breathing space (50) is composed of a conical section (53) and a cylindrical section (54) with a constant diameter. The overall result is the shape of a nozzle, such as the diverging part of a de Laval nozzle. The ground electrode and the center electrode are arranged in the cylindrical section of the breathing space, for example.

1-12. (canceled)

13. A spark plug with a longitudinal axis, comprising:
a housing with a longitudinal bore, as a result of which the housing has a housing wall with an inner face;
an insulator which is arranged within the housing and has a combustion chamber-side insulator tip which is flush with a plane extending perpendicularly to the longitudinal axis;
a center electrode arranged at least partially within the insulator; and
a ground electrode which is arranged within the housing, wherein the ground electrode and the center electrode are arranged such that they together form a spark gap, and the spark gap is within the housing;
wherein the housing has, at its combustion chamber-side end, a first inside diameter, and within the housing in the plane, a second inside diameter, wherein the first inside diameter is greater than the second inside diameter, so that a breathing space formed within the housing tapers from its combustion chamber-side end to its combustion chamber-remote end.

14. The spark plug according to claim 13, wherein the second inside diameter corresponds to 35% to 80% of the first inside diameter.

15. The spark plug according to claim 13, wherein the insulator tip delimits the breathing space at least partially at its combustion chamber-remote end.

16. The spark plug according to claim 13, wherein the housing wall of the housing laterally delimits the breathing space, resulting in a tapered shape of the breathing space.

17. The spark plug according to claim 16, wherein the shape of the breathing space results from straight surfaces of the inner face of the housing wall, wherein a first transition from the inner face of the housing wall to a combustion chamber-side end face of the housing, and/or a second transition from the inner face of the housing wall to a surface of the housing that delimits the breathing space at its combustion chamber-remote end, are rounded.

18. The spark plug according to claim 16, wherein the shape of the breathing space includes a plurality of partial surfaces of the inner face of the housing wall that are lined up in parallel with the longitudinal axis, wherein a single partial surface is straight or curved and different partial surfaces have different radii of curvature, so that overall a curved shape of the breathing space arises.

19. The spark plug according to claim 16, wherein the shape of the breathing space includes a conical section and a cylindrical section with a constant diameter.

20. The spark plug according to claim 16, wherein the breathing space is rotationally symmetrical and/or mirror-symmetrical, wherein the longitudinal axis of the spark plug is an axis of symmetry for the breathing space.

21. The spark plug according to claim 16, wherein the shape of the breathing space is rotationally symmetrical and/or mirror-symmetrical, wherein an axis of symmetry of the breathing space is at a distance from the longitudinal axis of the spark plug.

22. The spark plug according to claim 16, wherein the shape of the breathing space is asymmetrical.

23. The spark plug according to claim 13, wherein a cap is arranged at the combustion chamber-side end of the housing, so that the spark plug is a pre-chamber spark plug.

24. The spark plug according to claim 13, wherein the spark plug is a hydrogen spark plug which is configured to be used in a hydrogen-powered engine and to ignite an ignitable hydrogen-containing fuel-air mixture.
